(19) United States
(12) Patent Application Publication
(10) Pub. No.: US 2015/0254856 A1
(43) Pub. Date: Sep. 10, 2015

(54) SMART MOVING OBJECT CAPTURE METHODS, DEVICES AND DIGITAL IMAGING SYSTEMS INCLUDING THE SAME

(71) Applicant: Samsung Electronics Co., Ltd., Suwon-Si (KR)

(72) Inventor: Dmitriy RUDOY, Haifa (IL)

(73) Assignee: SAMSUNG ELECTRONICS CO., LTD., Suwon-Si (KR)

(21) Appl. No.: 14/196,766

(22) Filed: Mar. 4, 2014

(51) Int. Cl. G06T 7/00; G06T 7/20; H04N 5/232

(52) U.S. Cl. CPC G06T 7/0022; H04N 5/232; G06T 7/0002; G06T 7/0079; G06T 7/20

(57) ABSTRACT

An image capture system includes: an image sensor; a scene separation circuit; and an image selector. The image sensor is configured to capture a plurality of images of a scene including an object portion and a background portion. The scene separation circuit configured to: calculate a sharpness value for pixels of each of the plurality of images; and calculate, for each of the plurality of images, a distance between a sharpness of the background portion and a sharpness of the object portion based on the calculated sharpness values for the pixels. The image selector is configured to select an output image from among the plurality of images based on the calculated distances.

### BACKGROUND

There are two approaches to photographing moving objects: the freezing motion approach and the capturing the motion approach. The freezing motion approach is simpler and commonly used by amateur photographers. In this approach, the user takes photos using a faster shutter speed in an effort to maintain relatively high sharpness of the entire image. This mode is commonly referred to “sport mode” in consumer cameras. In some cases, however, a photographer wishes to emphasize the motion itself, which is not captured in the freezing motion approach.

The capturing the motion approach allows the user to emphasize the motion of the object that is the focus of the photo. This more complicated technique is referred to as “panning.” The panning technique uses slower shutter speeds to blur the background while still maintaining a relatively sharp object. The panning technique requires the photographer to track the object as precisely as possible to maintain the sharpness of the object.

Conventionally, the panning technique requires working in shutter speed priority mode, tracking the object and filtering (sometimes manually) of multiple shots taken by the photographer. Because tracking an object closely can be difficult, a burst of images is usually taken sequentially. However, only a few of the images maintain the desired sharpness of the main object. Because of this complexity, this technique is not often used by amateurs and casual photographers. It is also not readily available in consumer cameras at the present time.

### SUMMARY

At least one example embodiment provides an image capture method comprising: capturing a plurality of images of a scene including an object portion and a background portion; first calculating a sharpness value for pixels of each of the plurality of images; second calculating, for each of the plurality of images, a distance between a sharpness of the background portion and a sharpness of the object portion based on the calculated sharpness values for the pixels; and selecting an output image from among the plurality of images based on the calculated distances.

At least one other example embodiment provides an image capture system including: an image sensor; a scene separation circuit; and an image selector. The image sensor is configured to capture a plurality of images of a scene including an object portion and a background portion. The scene separation circuit configured to: calculate a sharpness value for pixels of each of the plurality of images; and calculate, for each of the plurality of images, a distance between a sharpness of the background portion and a sharpness of the object portion based on the calculated sharpness values for the pixels. The image selector is configured to select an output image from among the plurality of images based on the calculated distances.

At least one other example embodiment provides a tangible computer readable storage medium storing computer-executable instructions that, when executed on a computer device, cause the computer device to execute an image capture method comprising: capturing a plurality of images of a scene including an object portion and a background portion; first calculating a sharpness value for pixels of each of the plurality of images; second calculating, for each of the plurality of images, a distance between a sharpness of the background portion and a sharpness of the object portion based on the calculated sharpness values for the pixels; and selecting an output image from among the plurality of images based on the calculated distances.

According to at least some example embodiments, the scene separation circuit may compare the calculated distances for the plurality of images, and the image selector may select, as the output image, an image from among the plurality of images having a maximum calculated distance.

Each calculated distance may be stored in association with a corresponding image.

The image capture system may further include a display unit configured to display the selected output image.

The object may be at a center portion of each of the plurality of images.

According to at least some example embodiments, the scene separation circuit may: classify, for each of the plurality of images, each of the pixels of the image as one of a background pixel and an object pixel based on the calculated sharpness values; calculate the sharpness of the background portion based on the background pixels; and calculate the sharpness of the object portion based on the object pixels. The scene separation circuit may classify, for each of the plurality of images, each pixel of the image as one of the background pixel and the object pixel according to a sharpness distribution for the image.

The image capture system may further include: a post-processing circuit to enhance blur of the background portion of the output image by decreasing the sharpness of the background portion of the output image. The post-processing circuit may decrease sharpness values for pixels of the background portion of the output image while maintaining sharpness values for pixels of the object portion of the output image. For example, the post-processing circuit may estimate a blur kernel for the background portion of the output image, and apply the blur kernel to pixels of the background portion of the output image.

### BRIEF DESCRIPTION OF THE DRAWINGS

Example embodiments will become more appreciable through the description of the drawings in which:

FIG. 1 is a block diagram of a smart moving object capture system according to an example embodiment;

FIG. 2 is a block diagram of an image sensor according to an example embodiment;

FIG. 3 is a front view of a camera according to an example embodiment;

FIG. 4 is a rear view of the camera shown in FIG. 3;

FIG. 5A is a flow chart illustrating a method for smart moving object image capture according to an example embodiment;

FIG. 5B is a flow chart illustrating a method for smart moving object image capture according to another example embodiment; and

FIG. 6 illustrates an electronic device including a smart moving object capture system according to an example embodiment.

### DETAILED DESCRIPTION

Example embodiments will now be described more fully with reference to the accompanying drawings. Many alternate forms may be embodied and example embodiments should not be construed as limited to example embodiments set forth herein. In the drawings, like reference numerals refer to like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., digital single lens reflex (DSLR) cameras, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments provide methods, devices, and imaging systems that enable “capturing the motion” type of images to be more easily obtained by providing a dedicated “panning” mode for image capture systems such as cameras or other electronic devices including, connected to, or associated with a camera. Example embodiments also provide computer-readable storage mediums storing computer-executable instructions that enable “capturing the motion” type of images to be more easily obtained by providing a dedicated “panning” mode.

When operating in the panning mode an image capture system according to at least one example embodiment may utilize slower shutter speeds to capture a series of images, and then automatically select an image from among the captured series of images to be stored and/or displayed to the user.

According to at least one example embodiment, when capturing the series of images, the user need only keep the object in the center of view (e.g., in the center of the frame of view of the viewfinder) while the image capture system continuously keeps the center of the view in focus. After capturing the series of images, the image capture system chooses/selects an image from among the series of images by maximizing the difference between the blur (or sharpness) levels between the center portion and the remaining portions of the images.

In at least one other example embodiment, the user need not maintain the object in the center of view, but only relatively steady somewhere inside the frame of view of the image capture system. The system focuses on the object continuously regardless of the particular location of the object in the frame.

When the focus is at the center of the frame of view, to distinguish between images in terms of quality, the image capture system estimates the sharpness of an image around the location of the object (e.g., at or near the center of the frame of view) and near the boundary of the scene. In one example, the sharpness may be estimated using relatively simple high pass filters. The image capture system selects the image having the maximum difference between the amount of high frequencies found in the center of the scene and those near the boundary.

When the focus is not necessarily at the center, the image capture system evaluates a separation of two modes of a sharpness distribution. In this case, regions of the image for which blur is relatively low (and thus, sharpness is relatively high) represent the object, while the blurred regions with relatively low sharpness levels are considered background.

In yet another example embodiment, the image capture system may utilize a faster shutter speed to maintain the sharpness of the object, and the image capture system may increase the motion blur of the background. In this case, the image capture system may enhance the blur of the background using, for example, a horizontal motion blur kernel.

Since the image capture system allows capturing several images in a row (e.g., continuously and/or consecutively) (with, e.g., slow shutter speed priority), and then automatically selects an image from among the captured images, the methods discussed herein may be utilized as an ordinary image capture scenario.

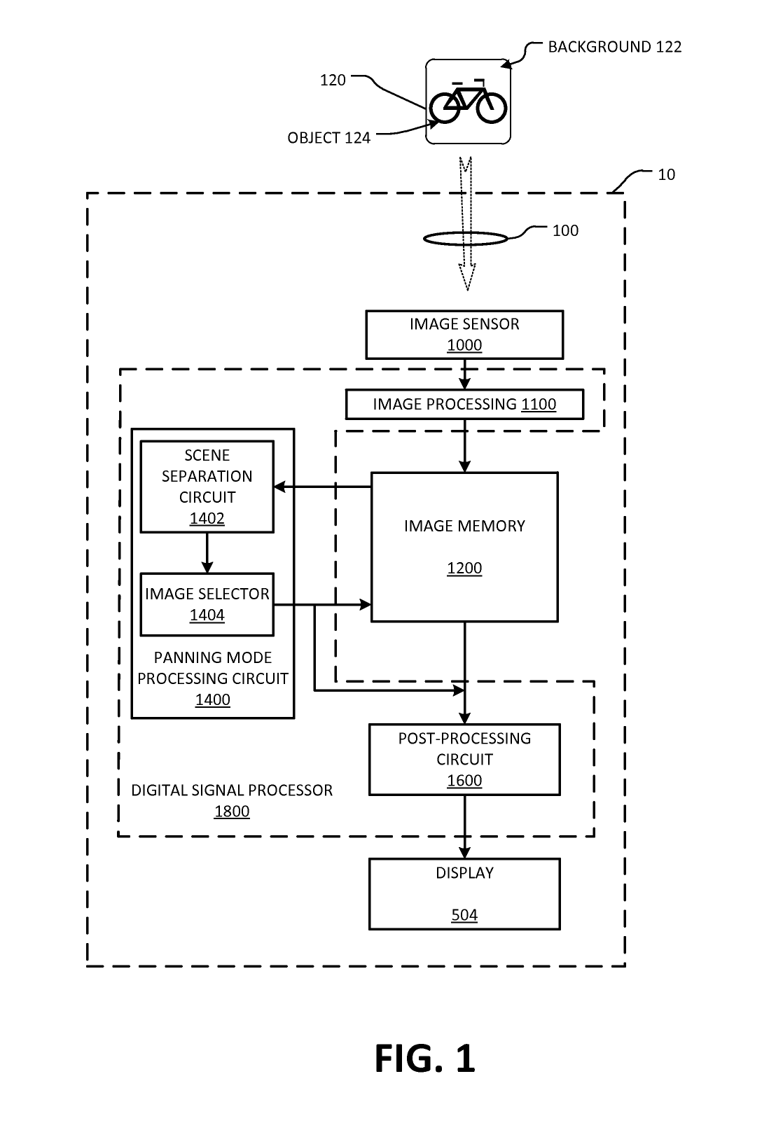

FIG. 1 is a block diagram of a smart moving image capture system according to an example embodiment. The smart moving image capture system shown in FIG. 1 may be a camera (e.g., digital single-lens reflex (DSLR), point-and-shoot, etc.) or other electronic device (e.g., laptop computer, mobile phone, smartphone, tablet PC, etc.) including, associated with or connected to a camera.

The smart moving image capture system shown in FIG. 1 will be described with regard to example operation in a panning mode scene selection or setting. However, it should be understood that the image capture system may operate in other conventional modes, and may be configured to capture images in more normal and/or conventional operations.

Referring to FIG. 1, the smart moving image capture system 10 includes a photographic lens unit 100, an image sensor 1000, an image memory 1200, a digital signal processor (DSP) 1800 and a display 504.

The lens unit 100 includes focusing optics (e.g., one or more lenses and/or mirrors) to focus and form an image of a scene 120 on the image sensor 1000 using subject light passing through the lens unit 100. As shown in FIG. 1, the scene 120 includes an object (or object portion) 124 and a background (or background portion) 122. Because lens units and focusing optics are generally well-known a detailed discussion is omitted.

In example operation, the image sensor 1000 repeatedly captures images of the scene 120 including the object 124 and the background 122 during a panning mode capture interval, and stores the captured images in the image memory 1200.

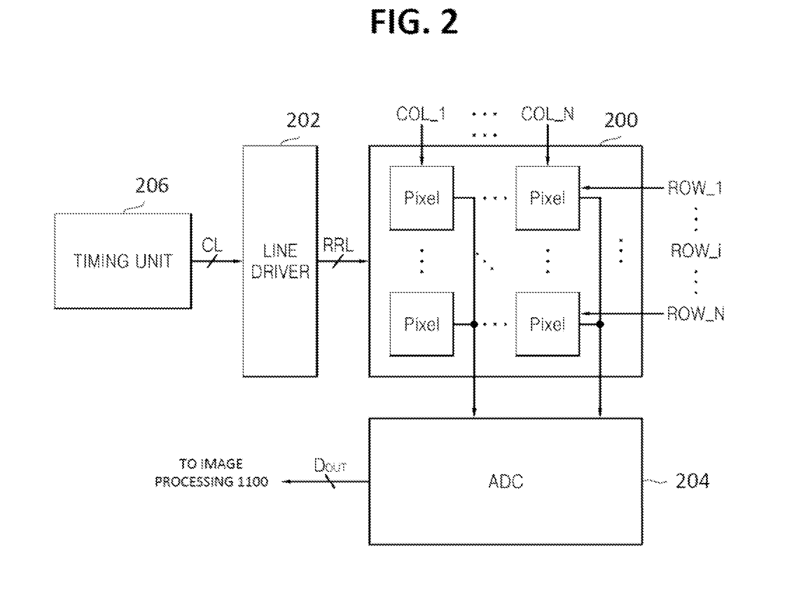

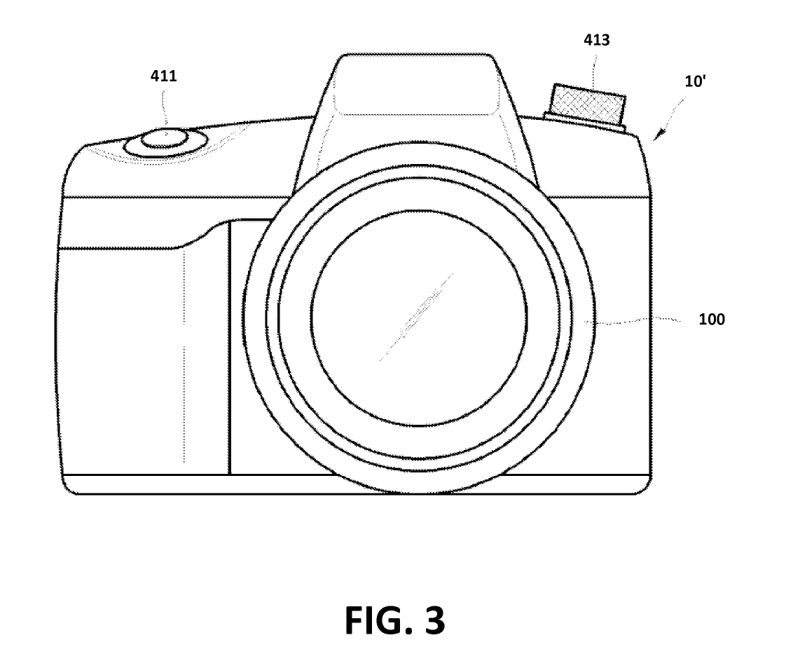

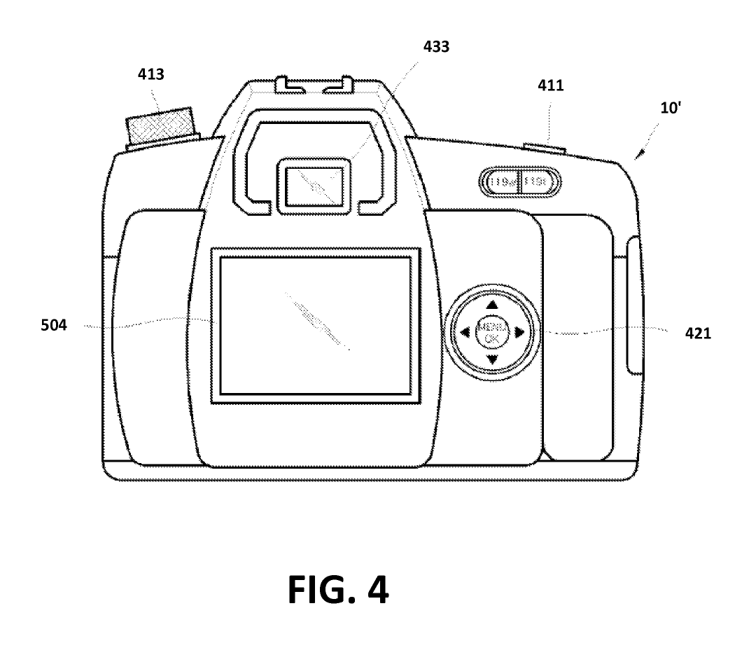

In one example, a user initiates the panning mode capture interval by pressing a shutter-release button (e.g., shown in FIGS. 3 and 4), and ends the interval by releasing the shutter-release button. During the panning mode capture interval, a shutter (not shown) is repeatedly opened and closed according to a selected shutter speed to repeatedly expose the image sensor 1000 to light. The panning mode capture interval includes a plurality of image capture periods. During each image capture period, the image sensor 1000 captures an image of the scene 120. For example, during an image capture period the image sensor 1000 is exposed to light (e.g., for the duration of an exposure period), pixel signals representing light incident on the pixels of the image sensor 1000 are readout, and image data representing the scene is generated based on the pixel signals. The image sensor 1000 stores the captured images in the image memory 1200. An example embodiment of the image sensor 1000 will be discussed in more detail later with regard to FIG. 2.

According to at least one example embodiment, the image capture device may utilize slower shutter speeds in the panning mode to capture a series of images of the scene 120 during the panning mode capture interval. The shutter speed may be selected based on the nature of the scene 120 and may be controlled by the user in any conventional well-known manner. For a relatively slow scene, the shutter speed may be about 1/20 seconds, whereas for faster scenes the shutter speed may be about 1/60 seconds. The shutter speed may determine the duration of the image capture interval.

Still referring to FIG. 1, the image memory 1200 may be any well-known non-volatile memory and/or combination of volatile and non-volatile memories. Because such memories are well-known, a detailed discussion is omitted. In one specific example, the image memory 1200 may be a first-in-first-out (FIFO) memory such that the stored images are read out from the image memory 1200 in order from the first captured image (oldest) image to most recent image (newest image).

FIG. 2 is a more detailed block diagram of an example embodiment of the image sensor 1000 shown in FIG. 1. In the example shown in FIG. 2, the images sensor is a complementary-metal-oxide-semiconductor (CMOS) image sensor.

Referring to FIG. 2, a timing unit or circuit 206 controls a line driver 202 through one or more control lines CL. In one example, the timing unit 206 causes the line driver 202 to generate a plurality of transfer pulses (e.g., readout and/or shutter). The line driver 202 outputs the transfer pulses to a pixel array 200 over a plurality of read and reset lines RRL.

The pixel array 200 includes a plurality of pixels arranged in an array of rows ROW_1-ROW_N and columns COL_1-COL_N. As discussed herein, rows and columns may be collectively referred to as lines. Each of the plurality of read and reset lines RRL corresponds to a line of pixels in the pixel array 200. In FIG. 2, each pixel may be an active-pixel sensor (APS), and the pixel array 200 may be an APS array.

Although example embodiments may be discussed herein with regard to lines (e.g., rows and/or columns) of a pixel array, it should be understood that the same principles may be applied to pixels grouped in any manner.

In more detail with reference to example operation of the image sensor in FIG. 2, during an image capture period, transfer pulses for an i-th line ROW_i (where i={1, . . . , N}) of the pixel array 200 are output from the line driver 202 to the pixel array 200 via an i-th one of the read and reset lines RRL. In one example, the line driver 202 applies a shutter transfer pulse to the i-th line ROW_i of the pixel array 200 to begin the exposure or integration period for that row. The exposure period is a portion of the image capture period discussed above with regard to FIG. 1. After a given, desired or predetermined exposure time, the line driver 202 applies a readout transfer pulse to the same i-th line ROW_i of the pixel array 200 to end the exposure period. The application of the readout transfer pulse also initiates reading out of pixel information (e.g., exposure data) from the pixels in the i-th line ROW_i.

The analog-to-digital converter (ADC) 204 converts the output voltages from the i-th line ROW_i of readout pixels into a digital signal (or digital data). An ADC 204 (e.g., having a column parallel-architecture) converts the output voltages into a digital signal (e.g., in parallel). The ADC 204 then outputs the digital data (or digital code) D_{OUT} to a next stage processor such as the image processing circuit 1100 of the digital signal processor (DSP) 1800 in FIG. 1. The image processing circuit 1100 and the digital signal processor 1800 will be discussed in more detail later.

Returning to FIG. 1, as mentioned above the image capture system 10 includes a digital signal processor 1800. The digital signal processor 1800 includes: an image processing circuit 1100; a panning mode processing circuit 1400; and a post processing circuit 1600.

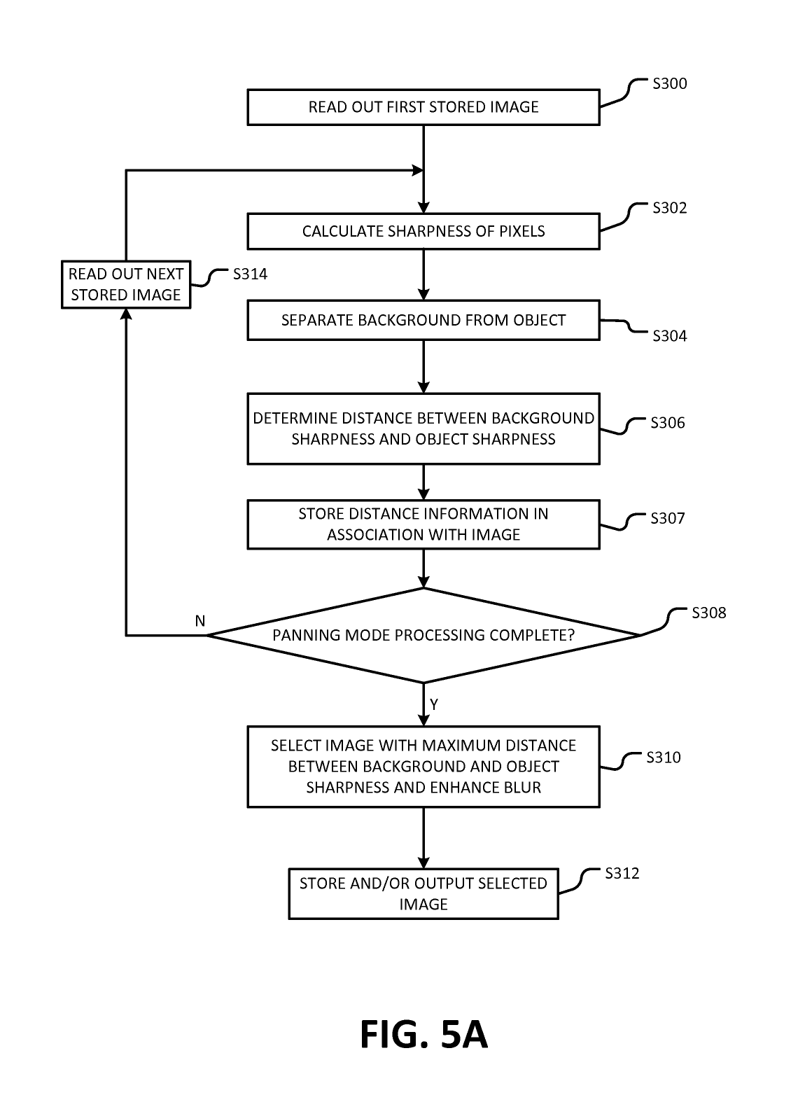

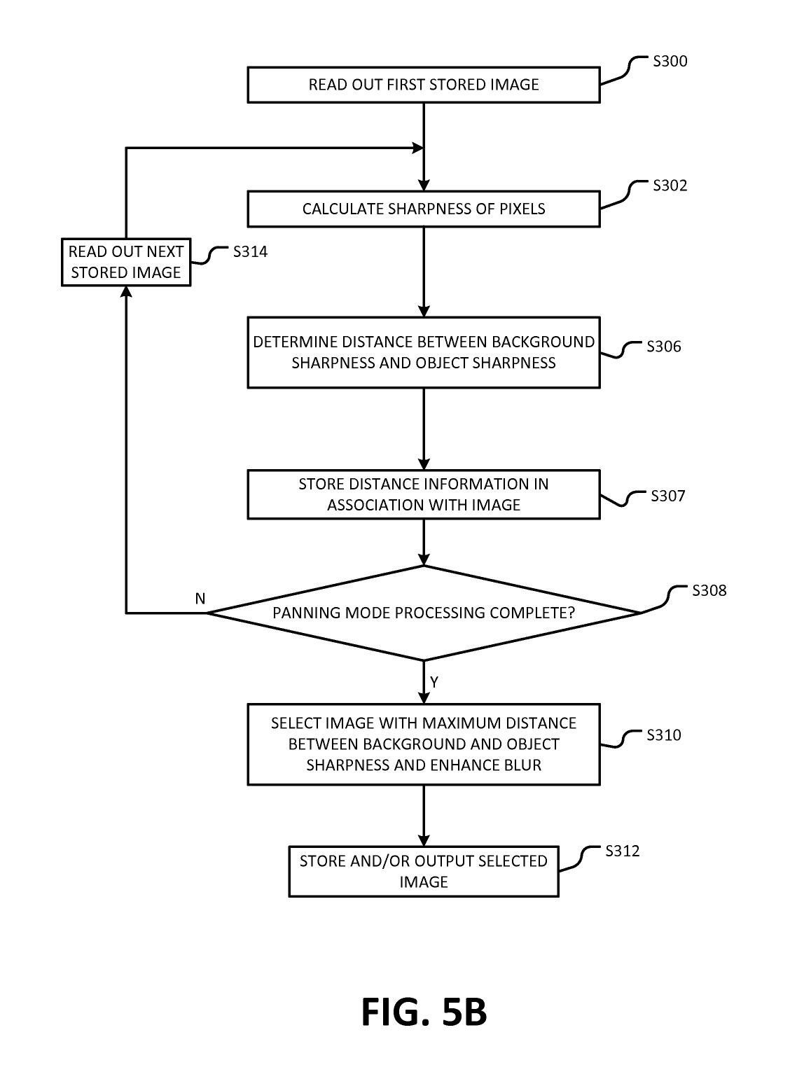

According to at least one example embodiment, the image capture system captures a plurality of images of a scene including an object and a background. The panning mode processing circuit 1400 then calculates, for each of the plurality of images, a sharpness value for pixels of the image, and a distance between a sharpness of the background and a sharpness of the object based on the sharpness values for the pixels. The panning mode processing circuit 1400 then selects an output image from among the plurality of images based on the calculated distances. Example operation and functionality of the digital signal processor 1800 and its components shown in FIG. 1 will be discussed in more detail with regard to FIGS. 5A and 5B.

Although the image memory 1200 is shown as separate from the digital signal processor 1800 in FIG. 1, it should be understood that the image memory 1200 may be included along with the digital signal processor 1800 on a single or multiple chips.

As mentioned above, according to at least one example embodiment, the smart moving image capture system 10 may be embodied as a camera.

FIG. 3 illustrates a front side of an example embodiment of a digital single lens reflex (DSLR) camera 10′.

Referring to FIG. 3, the DSLR camera 10′ includes: a shutter-release button 411; a mode dial 413; and the lens unit 100. Although not shown, the DSLR camera 10′ in FIG. 3 also includes the components shown in FIG. 1.

The shutter-release button 411 of the DSLR camera 10′ opens and closes the image capture device, for example, the image sensor 1000 shown in FIGS. 1 and 2 to expose the image capture device to light for the image capture time interval. The shutter-release button 411 also operates along with an aperture (not shown) to appropriately expose a scene (e.g., scene 120 in FIG. 1) so as to record an image of the scene in the image memory 1200. As discussed above, in the panning mode, the user may initiate the panning mode capture interval by pressing a shutter-release button 411, and the panning mode capture interval may be ended when the user releases the shutter-release button 411.

The mode dial 413 is used to select a photographing mode. In one example, the mode dial 413 of the DSLR camera 10′ may support an auto (auto photographing) mode, a scene mode, an effect mode, an A/S/M mode, etc., which are generally well-known. The auto mode is used to minimize setup by a user, and to more rapidly and conveniently photograph an image according to the intensions of the user. The scene mode is used to set a camera according to photographing conditions or conditions of an object. The effect mode is used to give a special effect to image photographing, for example, effects such as continuous photographing, scene photographing, etc. The A/S/M mode is used to manually set various functions including the speeds of an aperture and/or a shutter to photograph an image.

The mode dial 413 also supports the panning mode, which causes the camera to operate in accordance with one or more example embodiments discussed herein. In this case, the mode dial 413 may have a separate panning mode selection.

FIG. 4 illustrates a backside of the DSLR camera 10′ of FIG. 3.

Referring to FIG. 4, the backside of the DSLR camera 10′ includes: a viewfinder 433; a wide angle-zoom button 119w; a telephoto-zoom button 119t; a function button 421; and the display or display unit 504.

The viewfinder 433 is a display screen through which a composition of the scene 120 to be photographed is set.

The wide angle-zoom button 119w or the telephoto-zoom button 119t is pressed to widen or narrow a view angle, respectively. The wide angle-zoom button 119w and the telephoto-zoom button 119t may be used to change the size of a selected exposed area. Because these buttons and their functionality is well-known, a more detailed discussion is omitted.

Still referring to FIG. 4, the function button 421 includes up, down, left, right, and MENU/OK buttons. The function button 421 is pressed to execute various menus related to operations of the DSLR camera 10′. The up, down, left, right, and MENU/OK buttons may be used as shortcut keys, and the functions of the function button 421 may vary as desired. In an alternative to using the mode dial 413, a user may utilize the function button 421 to set the DSLR camera 10′ in the panning mode.

FIG. 5A illustrates a panning mode image processing method according to an example embodiment. The image processing method shown in FIG. 5A will be discussed with regard to the smart moving image capture system, and more particularly the digital signal processor 1800, shown in FIG. 1 for the sake of clarity. Moreover, the image processing method shown in FIG. 5A will be described with regard to images of the scene 120 captured by the image sensor 1000, processed by the image processing circuit 1100 and stored at the image memory 1200. However, the images may be processed as discussed with regard to FIG. 5A in real-time and then stored in the image memory 1200.

Referring to FIG. 5A, at S300 the panning mode processing circuit 1400 reads out a first of the stored images of the scene 120 from the image memory 1200.

At S302, the scene separation circuit 1402 calculates the sharpness of each pixel in the first image of the scene 120. In this context, the sharpness of each pixel is indicative of the relative motion of the pixel image. And, the relative motion of the pixel image is indicative of whether a pixel is associated with the background 122 of the scene 120 or the object 124 of the scene 120. In a simple example, the scene separation circuit 1402 may calculate sharpness of a pixel using a high-pass filter. In this example, the scene separation circuit 1402 uses a high-pass filter to calculate the difference between the sharpness of the current pixel and the sharpness of those pixels adjacent (e.g., directly adjacent) to the current pixel. On the pixel level, this calculation is indicative of the edges of the image and the sharpness of the pixel may be calculated by summing the edges of the image. It should be understood that any method for calculating pixel sharpness may be used.

By calculating the sharpness of each pixel at S302, the scene separation circuit 1402 generates and/or forms a sharpness map for the image.

At S304, the scene separation circuit 1402 separates the pixels associated with the background 122 (hereinafter referred to as “background pixels”) of the scene 120 from the pixels associated with the object 124 (hereinafter referred to as “object pixels”) of the scene 120. In one example, the scene separation circuit 1402 classifies pixels as background pixels or object pixels by comparing the calculated sharpness of each pixel with a sharpness threshold value. The pixels having a sharpness greater than or equal to the sharpness threshold are classified as object pixels, whereas the pixels having sharpness less than the sharpness threshold value are classified as background pixels. According to at least some example embodiments, the sharpness threshold values may be image dependent; that is, for example the sharpness threshold may vary based on the image.

In one example, the sharpness threshold value may be about 40% of the median sharpness of the image. In this case, the scene separation circuit 1402 classifies pixels having sharpness values below 40% of the median sharpness of the image as background pixels. On the other hand, the scene separation circuit 1402 classifies pixels having more than about 60% of the median sharpness value as object pixels. It should be noted that using median of the sharpness of the image may be more robust to outliers than using maximum and minimum sharpness values.

In another example, the scene separation circuit 1402 may apply a more complicated object/background separation methodology. For example, rather applying a threshold directly to the sharpness values, the scene separation circuit 1402 separates the pixels based on a sharpness distribution. In this case, the scene separation circuit 1402 estimates a two-mode Gaussian distribution from all available sharpness values. The lobe of the Gaussian distribution with the lower sharpness value corresponds to the object, whereas the lobe of the Gaussian distribution with the higher sharpness value corresponds to the background.

At S306, the image selector 1404 determines a distance between the sharpness of the background 122 and the sharpness of the object 124 separated at S304.

In one example, at S306 the image selector 1404 calculates an average sharpness of the background pixels and an average sharpness of the object pixels, and then calculates the difference between the average background pixel sharpness and the average object pixel sharpness.

In another example, at S306 the image selector 1404 calculates the average sharpness of the object 124 and of the background 122 using regional averaging. For example, the image selector 1404 down-scales a “sharpness map” of the image by factors of 2, 4, and 8, and calculates the average sharpness of the object 124 and background 122 in the scaled sharpness maps. The image selector 1404 calculates the final sharpness as a weighted average of the average sharpness for each scaled sharpness map. In this case, the smaller the scale of the sharpness map, the higher the weighting. For example, a sharpness map down-scaled by a factor of 8 is smaller in scale than a sharpness map down-scaled by a factor of 2. In one specific example, weights of ⅙, ⅓ and ½ may be applied to the sharpness maps down-scaled by factors of 2, 4, and 8, respectively.

The difference between the average background pixel sharpness and the average object pixel sharpness is used as the distance between the sharpness of the background 122 and the sharpness of the object 124.

In the example in which the scene separation circuit 1402 separates the pixels using a sharpness distribution such as the two-mode Gaussian distribution, the distance between the peaks of the two lobes represents the distance between the sharpness of the object and the sharpness of the background.

Still referring to FIG. 5A, at S307 the image selector 1404 stores the calculated distance in association with the image in the image memory 1200. The image selector 1404 may store the distance information in association with the image in any well-known manner. In one example, the distance information may be stored in a lookup table.

At S308, the panning mode processing circuit 1400 determines whether the panning mode processing of the captured images is complete. In one example, the panning mode processing circuit 1400 determines that the panning mode processing is complete if distances between sharpness of the background 122 (also referred to as “background sharpness”) and the sharpness of the object 124 (also referred to as “object sharpness”) for all captured images obtained during the panning mode capture interval have been calculated/determined.

If the panning mode processing circuit 1400 determines that the panning mode processing is not complete, then the panning mode processing circuit 1400 reads out a next image from the image memory 1200 at S314, returns to S302 and continues as discussed above for the next stored image acquired during the panning mode capture interval.

Returning to S308, if the panning mode processing circuit 1400 determines that the panning mode processing of images captured during the panning mode capture interval is complete, then the image selector 1404 selects the image having a maximum distance between the sharpness of the background 122 and the sharpness of the object 124 at S310. In one example, the image selector 1404 compares the calculated distances associated with each of the images acquired during the panning mode capture interval to identify the image having the maximum associated distance between the sharpness of the background 122 and the sharpness of the object 124.

According to at least one example embodiment, the image selector 1404 may select a single one of the images captured during the panning mode capture interval, and the remaining ones of the images may be discarded.

The image selector 1404 then stores the selected image in the image memory 1200 and/or outputs the selected image to the post processing circuit 1600. In another example, the image selector 1404 may output the selected image to the display 504, which displays the selected image to the user.

If output to the post processing circuit 1600, the smart moving image capture system 10 may enhance the blur of the background 122 by decreasing the sharpness of the background pixels. As is known, blur is essentially the opposite of sharpness, and thus, as the sharpness increases the blur decreases and vice-versa. By enhancing the blur (decreasing sharpness) of the background, the motion in the captured image may be emphasized.

Referring back to FIG. 1, in one example, the post-processing circuit 1600 enhances the blur of the background 122 of the image selected at S310. The post-processing circuit 1600 may enhance the blur of the background using any well-known methodology, for example, using defocus magnification.

In one example, the post-processing circuit 1600 utilizes the same sharpness map discussed above as a measure of defocus, wherein higher sharpness means lower defocus. The post-processing circuit 1600 increases the defocus (lowers sharpness) in the regions with relatively low sharpness using a blur kernel estimated from the same regions. Since the blur is, for the most part, motion blur, the post-processing circuit 1600 estimates the blur kernel. The post-processing circuit 1600 then applies gradual defocus decrease in the regions of mediocre sharpness to conceal different processing near the object contours. Because blur kernels such as these are generally well-known, a detailed discussion thereof is omitted.

FIG. 5B illustrates a panning mode image processing method according to another example embodiment. As with FIG. 5A, the image processing method shown in FIG. 5B will be discussed with regard to the smart moving image capture system shown in FIG. 1 for the sake of clarity. Moreover, the image processing method shown in FIG. 5B will be described with regard to images of the scene 120 captured by the image sensor 1000, processed by the image processing circuit 1100 and stored at the image memory 1200. However, the images may be processed as discussed with regard to FIG. 5B in real-time and then stored in the image memory 1200.

In the example embodiment shown in FIG. 5B the user maintains the object in the center of view while the image capture system continuously maintains the center of the view in focus. Accordingly, the center portion of the image corresponds to the object 124, whereas the other portions of the image correspond to the background 122.

Referring to FIG. 5B, at S300 the panning mode processing circuit 1400 reads out a first of the stored images of the scene 120 from the image memory 1200.

At S302, the scene separation circuit 1402 calculates the sharpness of each pixel in the first image of the scene 120 in the same manner as discussed above with regard to FIG. 5A.

Unlike the example embodiment shown in FIG. 5A, in the example embodiment shown in FIG. 5B the scene separation circuit 1402 need not separate the pixels associated with the background 122 (hereinafter referred to as “background pixels”) of the scene 120 from the pixels associated with the object 124 (hereinafter referred to as “object pixels”) of the scene 120 as discussed above with regard to S304 in FIG. 5A. Rather, the pixels at the center portion of the image are considered object pixels, and the pixels of the remaining portion of the image are considered background pixels. In this case, the center portion of the image may be determined by the user or the image capture system either during or prior to the image capture process. For example, the image capture system may present a box or circle (or any other polygonal or other delineation) identifying a portion of the frame-of-view to the user through the view finder. In this example, the user may track the object by maintaining the object within the box or circle.

Referring back to FIG. 5B, at S306 the image selector 1404 determines a distance between the sharpness of the background 122 and the sharpness of the object 124 in the same or substantially the same manner as discussed above with regard to FIG. 5A.

At S307, the image selector 1404 stores the calculated distance in association with the image in the image memory 1200 in the same or substantially the same manner as discussed above with regard to FIG. 5A.

At S308, the panning mode processing circuit 1400 determines whether the panning mode processing of the captured images is complete in the same or substantially the same manner as discussed above with regard to FIG. 5A.

If the panning mode processing circuit 1400 determines that the panning mode processing is not complete, then the panning mode processing circuit 1400 reads out a next image from the image memory 1200 at S314, returns to S302 and continues as discussed above for the next stored image acquired during the panning mode capture interval.

Returning to S308, if the panning mode processing circuit 1400 determines that the panning mode processing of images captured during the panning mode capture interval is complete, then the image selector 1404 selects the image having a maximum distance between the sharpness of the background 122 and the sharpness of the object 124 at S310 in the same or substantially the same manner as discussed above with regard to FIG. 5A.

The image selector 1404 then stores the selected image in the image memory 1200 and/or outputs the selected image to the post processing circuit 1600.

As discussed above with regard to FIG. 5A, if the selected image is output to the post processing circuit 1600, the smart moving image capture system 10 may enhance the blur of the background 122 by decreasing the sharpness of the background pixels. The smart moving image capture system 10 may enhance the blur of the background 122 in the same or substantially the same manner as discussed above with regard to FIG. 5A.

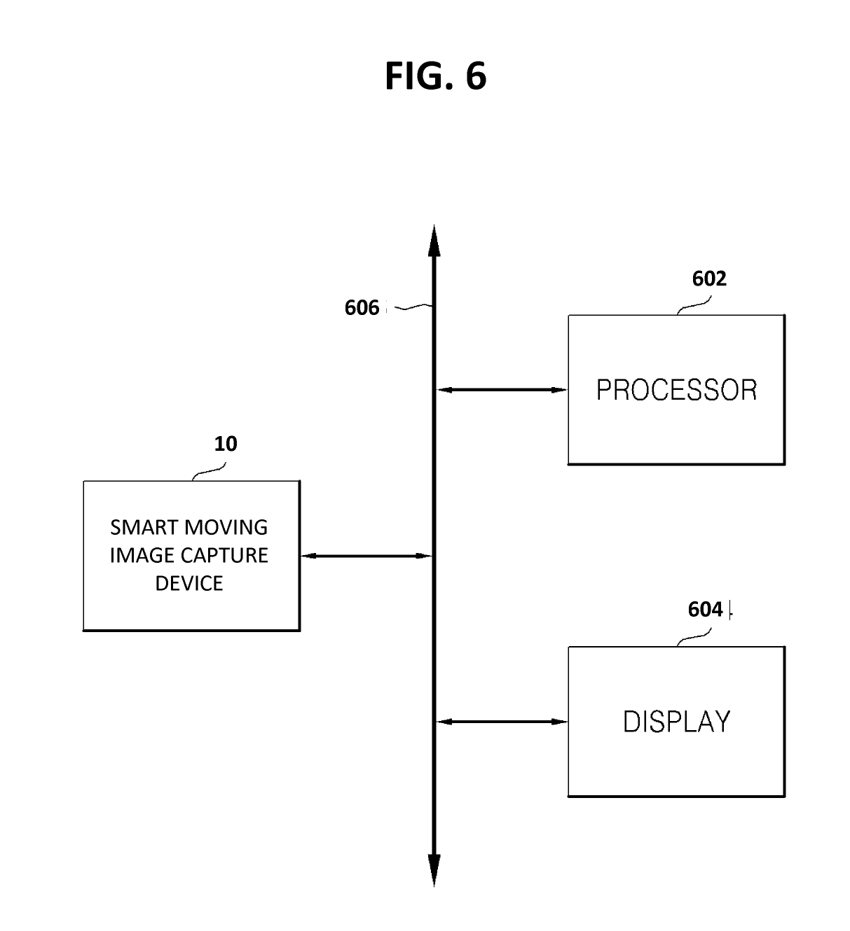

As mentioned above, the smart moving image capture system 10 may be a camera (e.g., digital single-lens reflex (DSLR), point-and-shoot, etc.) or be included in other electronic devices (e.g., laptop computer, mobile phone, smartphone, tablet PC, etc.) including a camera. FIG. 6 illustrates an electronic device including an image capture system 10. The electronic device shown in FIG. 6 may embody various electronic devices and/or systems such as a mobile phone, smart phone, personal digital assistant (PDA), laptop computer, netbook, tablet computer, MP3 player, navigation device, household appliance, or any other device utilizing camera or similar image capture system.

Referring to FIG. 6, a processor 602, the smart moving image capture system 10, and the display 604 communicate with each other via a bus 606. The processor 602 is configured to execute a program and control the electronic system. The smart moving image capture system 10 is configured to operate as discussed herein with regard to FIGS. 1 through 5. The processor 602 may be the same as or separate from the digital signal processor 1800 discussed herein. Moreover, the display 604 is the same as the display 504 discussed above. However, according to alternative example embodiments, the display 604 shown in FIG. 6 may be separate from the display 504.

The electronic device shown in FIG. 6 may be connected to an external device (e.g., a personal computer, a network, etc.) through an input/output device (not shown) and may exchange data with the external device.

The foregoing description of example embodiments has been provided for purposes of illustration and description. It is not intended to be exhaustive or limiting. Individual elements or features of a particular example embodiment are generally not limited to that particular example embodiment. Rather, where applicable, individual elements or features are interchangeable and may be used in a selected embodiment, even if not specifically shown or described. The same may also be varied in many ways. All such modifications are intended to be included within the scope of this disclosure.

What is claimed is:

1. An image capture method comprising:
capturing a plurality of images of a scene including an object portion and a background portion;
first calculating a sharpness value for pixels of each of the plurality of images;
second calculating, for each of the plurality of images, a distance between a sharpness of the background portion and a sharpness of the object portion based on the calculated sharpness values for the pixels; and
selecting an output image from among the plurality of images based on the calculated distances.

2. The image capture method of claim 1, further comprising:
comparing the calculated distances for the plurality of images; and wherein
the selecting step selects, as the output image, an image from among the plurality of images having a maximum calculated distance.

3. The image capture method of claim 1, further comprising:
storing each calculated distance in association with a corresponding image.

4. The image capture method of claim 1, further comprising:
at least one of storing and displaying the selected output image.

5. The image capture method of claim 1, wherein the object portion is at a center portion of each of the plurality of images.

6. The image capture method of claim 1, further comprising:
classifying, for each of the plurality of images, each of the pixels of the image as one of a background pixel and an object pixel based on the calculated sharpness values; and
calculating the sharpness of the background portion based on the background pixels; and
calculating the sharpness of the object portion based on the object pixels.

7. The image capture method of claim 6, wherein the classifying classifies, for each of the plurality of images, each pixel of the image as one of the background pixel and the object pixel according to a sharpness distribution for the image.

8. The image capture method of claim 1, further comprising:
enhancing blur of the background portion of the output image by decreasing the sharpness of the background portion of the output image.

9. The image capture method of claim 8, wherein the enhancing the blur of the background portion comprises:
decreasing sharpness values for pixels of the background portion of the output image while maintaining sharpness values for pixels of the object portion of the output image.

10. The image capture method of claim 8, wherein the enhancing blur of the background portion comprises:
estimating a blur kernel for the background portion of the output image; and
applying the blur kernel to pixels of the background portion of the output image.

11. An image capture system comprising:
an image sensor configured to capture a plurality of images of a scene including an object portion and a background portion;
a scene separation circuit configured to,
calculate a sharpness value for pixels of each of the plurality of images, and
calculate, for each of the plurality of images, a distance between a sharpness of the background portion and a sharpness of the object portion based on the calculated sharpness values for the pixels; and
an image selector configured to select an output image from among the plurality of images based on the calculated distances.

12. The image capture system of claim 11, wherein:
the scene separation circuit is configured to compare the calculated distances for the plurality of images; and
the image selector is configured to select, as the output image, an image from among the plurality of images having a maximum calculated distance.

13. The image capture system of claim 11, further comprising:
a memory configured to store each calculated distance in association with a corresponding image.

14. The image capture system of claim 11, further comprising:
a display unit configured to display the selected output image.

15. The image capture system of claim 11, wherein the object portion is at a center portion of each of the plurality of images.

16. The image capture system of claim 11, wherein the scene separation circuit is further configured to,
classify, for each of the plurality of images, each of the pixels of the image as one of a background pixel and an object pixel based on the calculated sharpness values,
calculate the sharpness of the background portion based on the background pixels, and
calculate the sharpness of the object portion based on the object pixels.

17. The image capture system of claim 16, wherein the scene separation circuit is configured to classify, for each of the plurality of images, each pixel of the image as one of the background pixel and the object pixel according to a sharpness distribution for the image.

18. The image capture system of claim 11, further comprising:
a post-processing circuit configured to enhance blur of the background portion of the output image by decreasing the sharpness of the background portion of the output image.

19. The image capture system of claim 18, wherein the post-processing circuit is further configured to decrease sharpness values for pixels of the background portion of the output image while maintaining sharpness values for pixels of the object portion of the output image.

20. The image capture system of claim 18, wherein the post-processing circuit is configured to,
estimate a blur kernel for the background portion of the output image, and
apply the blur kernel to pixels of the background portion of the output image.

21. A tangible computer readable storage medium storing computer-executable instructions that, when executed on a computer device, cause the computer device to execute an image capture method comprising:
capturing a plurality of images of a scene including an object portion and a background portion;
first calculating a sharpness value for pixels of each of the plurality of images;
second calculating, for each of the plurality of images, a distance between a sharpness of the background portion and a sharpness of the object portion based on the calculated sharpness values for the pixels; and
selecting an output image from among the plurality of images based on the calculated distances.

22. The tangible computer readable storage medium of claim 21, wherein the method further comprises:
comparing the calculated distances for the plurality of images; and wherein
the selecting step selects, as the output image, an image from among the plurality of images having a maximum calculated distance.

23. The tangible computer readable storage medium of claim 21, wherein the method further comprises:
storing each calculated distance in association with a corresponding image.

24. The tangible computer readable storage medium of claim 21, wherein the method further comprises:
at least one of storing and displaying the selected output image.

25. The tangible computer readable storage medium of claim 21, wherein the object portion is at a center portion of each of the plurality of images.

26. The tangible computer readable storage medium of claim 21, wherein the method further comprises:
classifying, for each of the plurality of images, each of the pixels of the image as one of a background pixel and an object pixel based on the calculated sharpness values; and
calculating the sharpness of the background portion based on the background pixels; and
calculating the sharpness of the object portion based on the object pixels.

27. The tangible computer readable storage medium of claim 26, wherein the classifying classifies, for each of the plurality of images, each pixel of the image as one of the background pixel and the object pixel according to a sharpness distribution for the image.

28. The tangible computer readable storage medium of claim 21, wherein the method further comprises:
enhancing blur of the background portion of the output image by decreasing the sharpness of the background portion of the output image.

29. The tangible computer readable storage medium of claim 28, wherein the enhancing the blur of the background portion comprises:
decreasing sharpness values for pixels of the background portion of the output image while maintaining sharpness values for pixels of the object portion of the output image.

30. The tangible computer readable storage medium of claim 28, wherein the enhancing blur of the background portion comprises:
estimating a blur kernel for the background portion of the output image; and
applying the blur kernel to pixels of the background portion of the output image.
